(19) United States
(12) Patent Application Publication
(10) Pub. No.: US 2022/0071836 A1
(43) Pub. Date: Mar. 10, 2022

(54) EDEMA REDUCING DEVICE

(71) Applicant: King Abdulaziz University, Jeddah (SA)

(72) Inventors: Abdulhameed Fouad Alkhateeb, Jeddah (SA); Hussain Bassi, Jeddah (SA)

(21) Appl. No.: 17/015,136

(22) Filed: Sep. 9, 2020

(51) Int. Cl. A61H 9/00

(52) U.S. Cl. CPC A61H 9/0071; A61H 2201/1409; A61H 2209/00; A61H 2201/1238; A61H 2205/06; A61H 2205/10; A61H 2201/165

(57) ABSTRACT

A device for applying air pressure to a portion of a body of a person is provided. The device includes a garment configured to be arranged distally of a joint of the body of the person, wherein the garment comprises a plurality of hollow rings configured for arrangement along a longitudinal axis of the portion of the body of the person, each of the plurality of hollow rings having a skin contacting surface and an air contacting surface, the skin contacting surface including a series of holes for supplying air directly to skin of the portion of the body of the person.

### FIELD OF THE INVENTION

The invention is generally related to a device for applying air pressure directly to the skin of a person suffering from edema.

### BACKGROUND OF THE INVENTION

The fluid in the lymphatic system helps remove waste and toxins from the bodily tissues. Some health conditions can cause lymph fluid to build up. In a healthy and active person, the interstitial fluid that “leaks” from the tissues and vascular system is normally and efficiently picked up by the lymphatic vessels and returned to circulation. Unlike the cardiovascular system, which has an active pump, namely the heart, to pump the blood through it, the lymphatic vessels are passive and do not have a similar active pump. The lymphatic vessels form a network of tubes that have “one-way” valves that allow fluid to move in one direction only, which is in the direction of the heart. When one moves their limbs, the smooth muscles constrict and relax. This action of the smooth muscles also squeezes the lymphatic vessels, which results in the liquid in them to be pushed upwards. Health conditions can interrupt the normal flow of lymph, causing lymph fluid to build up in a particular area of the body, often in the arms or legs, where it can cause swelling. This condition is called lymphedema.

People can develop lymphedema as a result of infections, cancer treatments that involve the removal of lymph nodes, and any condition that damages the lymphatic system. It also happens when the patient does not move, such as for elderly obese persons, bedridden patients, or if standing or sitting for long periods without moving, e.g. on long flights. In such cases, the muscles in the legs are not contracting and relaxing, so the interstitial fluid gathers in the lower extremities and is not salvaged by the lymphatic system so the foot and leg will become swollen. There are different solutions in the market such as wearing special socks (passive solution) to wearing a socks-like device usually made from plastic that is filled with air to “squeeze” the liquid back into the lymphatic system. Many of such devices use a closed air chamber usually arranged in a mesh configuration around the leg to apply pressure.

Novel solutions to address edema in the arms and legs are needed.

### SUMMARY

Disclosed herein is a device for applying air pressure via nozzles or jets to a person's arm or leg. Unlike previous techniques that surround the leg with a plastic or nylon bag that is filled with air thus applying pressure around the leg, the device disclosed herein delivers air from nozzles around the arm or leg and thus the pressure is delivered deeper into the tissue, mimicking a lymphatic massage.

An aspect of the disclosure provides a device for applying air pressure to a portion of a body of a person, comprising a garment configured to be arranged distally of a joint of the body of the person, wherein the garment comprises a plurality of hollow rings configured for arrangement along length of the garment, each of the plurality of hollow rings having a skin contacting surface including a series of holes for supplying air directly to skin of the portion of the body of the person. In some embodiments, each of the plurality of hollow rings is separately attachable to the body.

In some embodiments, the device comprises an air control unit, wherein the air control unit comprises an air inlet rotatably-coupled to a surface of a first component of the air control unit and fluidly coupled to an air outlet on an opposing surface of the first component, and a plurality of air outlets disposed through a thickness of a second component of the air control unit, each of the plurality of air outlets being fluidly connected to a corresponding one of the plurality of hollow rings.

In some embodiments, the first component and the second component are rotatably-coupled about a central axis of the air control unit. In some embodiments, the air inlet is arranged at the central axis of the air control unit. In some embodiments, the device comprises an air channel disposed through the thickness of the first component of the air control unit, wherein the air channel is fluidly-coupled with at least one of the plurality of air outlets disposed through the thickness of the second component of the air control unit based on a rotation of the first component and the second component about the central axis of the air control unit.

In some embodiments, the device comprises a motor operably coupled to the air control unit. In some embodiments, the device comprises a pump fluidly-coupled to the air inlet of the first component of the air control unit. In some embodiments, the device comprises processing circuitry configured to supply, via the pump, air to the air inlet of the first component of the air control unit, and rotate, via the motor and about the central axis of the air control unit, the first component of the air control unit relative to the second component of the air control unit.

In some embodiments, the device comprises a securing garment configured to be arranged proximally of the joint of the body of the person, the securing garment being rotatably-coupled to the garment arranged distally of the joint of the body of the person by a hinge, wherein the hinge comprises a first magnetic disc attached to the securing garment and a second magnetic disc attached the garment, relative rotation therebetween generating storable energy.

Another aspect of the disclosure provides a method for reducing edema in a subject in need thereof, comprising attaching a device as described herein to an arm or leg of the subject.

### BRIEF DESCRIPTION OF THE DRAWINGS

FIG. 1. A device for applying air pressure according to some embodiments of the disclosure.

FIGS. 2A-B. (A) Front view and (B) back view of a lower disk according to some embodiments of the disclosure.

FIGS. 3A-C. (A) Front view, (B) back view, and (C) crosssection of an upper disk according to some embodiments of the disclosure.

FIGS. 4A-C. (A) Front view, (B) back view, and (C) side view of an upper disk with central pipe attached according to some embodiments of the disclosure.

FIGS. 5A-B. (A) 2D front view and (B) 3D front view of an upper disk attached to a lower disk according to some embodiments of the disclosure.

FIGS. 6A-D. (A) Front view and (B) back view of an upper and lower disk with tubes attached according to some embodiments of the disclosure. (C) Front view and (D) back view of an upper and lower disk with tubes and a central pipe attached according to some embodiments of the disclosure.

FIGS. 7A-B. (A) Top view and (b) side view of an energy generator according to some embodiments of the disclosure.

### DETAILED DESCRIPTION

Embodiments of the disclosure provide a device which utilizes air jets from nozzles surrounding the arm or leg to help stimulate the muscles and the lymphatic vessels. Direct pressure to the skin using air jets has the advantage of reaching deep tissues and not limiting the pressure to superficial tissues thus helping with improved circulation. The device works to push any collected liquid upwards and into the lymphatic system. The use of nozzles or jets has the advantage of simulating a lymphatic drainage massage, which can reduce swelling and improve circulation throughout the lymphatic system. The lymphatic massage usually forms part of a treatment program called decongestive lymphatic therapy (DLT).

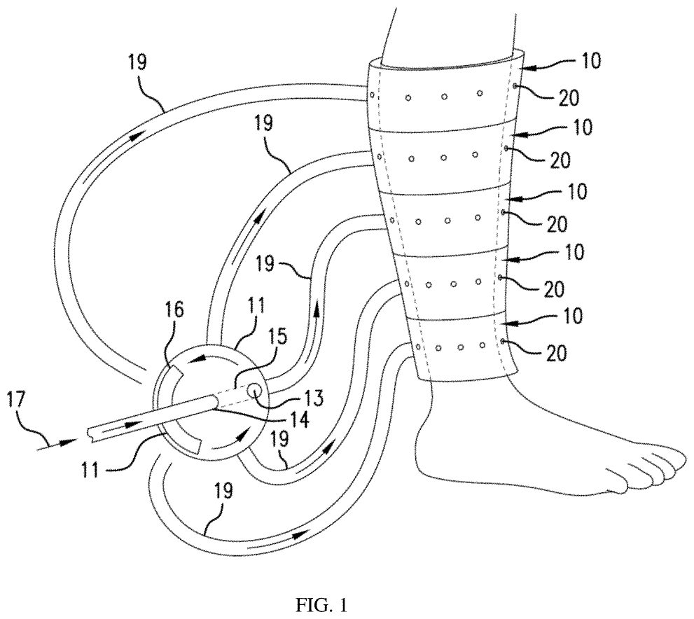

With reference to FIG. 1, the device comprises a plurality of hollow tubular rings (10) which may be arranged on a person's arm or leg one ring on top of the other ring (10). The rings are inflatable balloon-like structures. In use, the lowest ring is near the ankle or wrist and the uppermost ring near the knee or elbow. Thus, the device is not a continuous sleeve or sock, but rather separately attachable rings. Different sized rings may be provided depending on the patient's limb size (diameter). The user or therapist can choose the correct size ring to fit from smaller sizes for the bottom of the leg to larger sizes around the calf. Moreover, the user or therapist may select as many rings as needed to cover the entire length of the arm or leg (e.g. from the ankle to the knee) which may be, for example, from 2-10 rings, e.g. 5 rings.

The rings are formed from any flexible airtight material, such as plastic, rubber, nylon, or other fabric. Each ring has nozzles or jets (20) on the inside surface of the rings facing the patient's skin. Each ring is fed compressed air from a tube (19). In some embodiments, the nozzles are configured to be uniformly distributed around the limb. In other embodiments, the nozzles are configured to increase in density from the front to the back of the leg (i.e. there are more nozzles placed at the back of the leg).

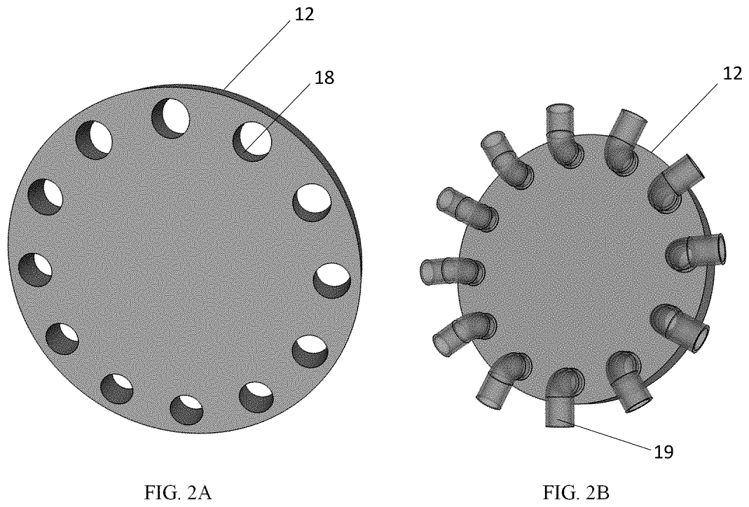

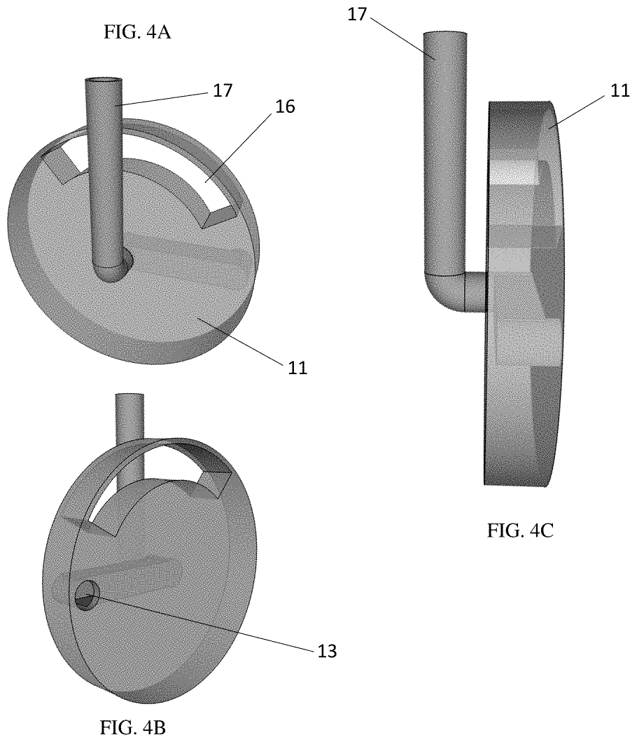

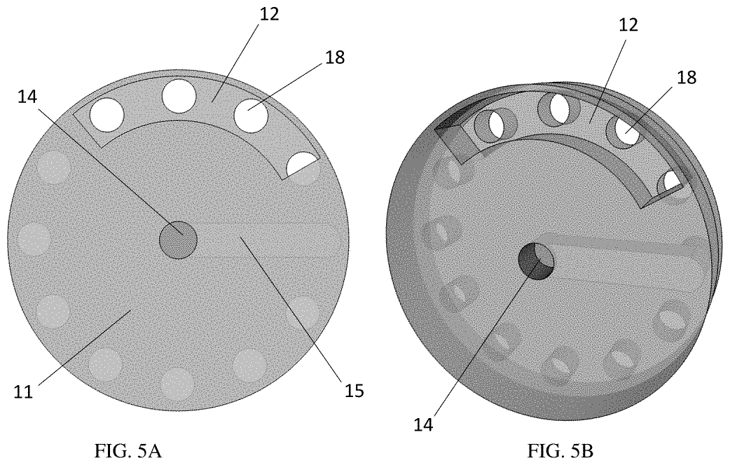

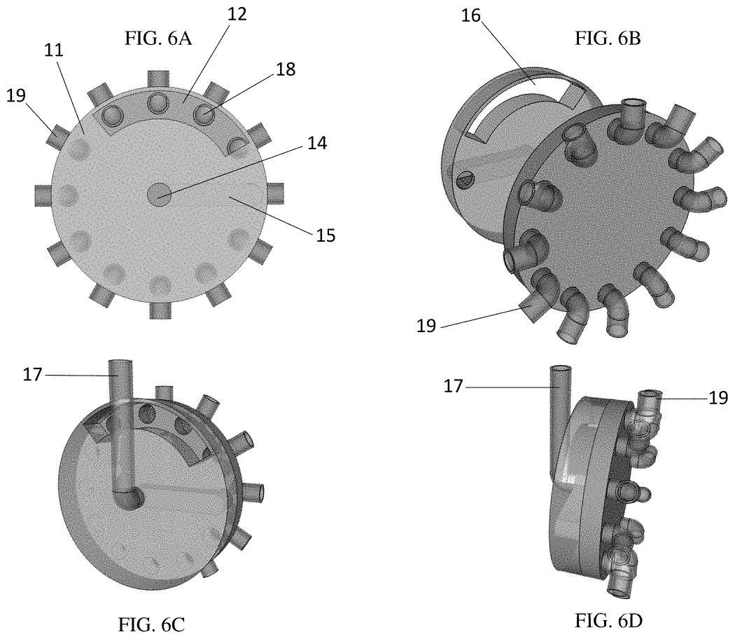

With reference to FIGS. 2-6, an Air Control Unit (ACU) (11+12) acts as an intermediary between an air pump and the rings. A primary function of the ACU is to control the inflation and deflation of the rings, thus controlling the air distribution from the bottom to the top of the arm or leg. The ACU is comprised of two disks superimposed on top of one another, an upper disk (UD) (11) and a lower disk (LD) (12). Each tube (19) from each ring is connected to a specific hole (18) in the lower disk (LD) (12) of the ACU. The LD of the ACU has several holes (18) located on its circumference. The tubes (19) are connected sequentially to the holes (18) on the LD of the ACU with each successive tube (19) connected to the next hole (18) in the direction of rotation of the upper disk (UD) (11) of the ACU.

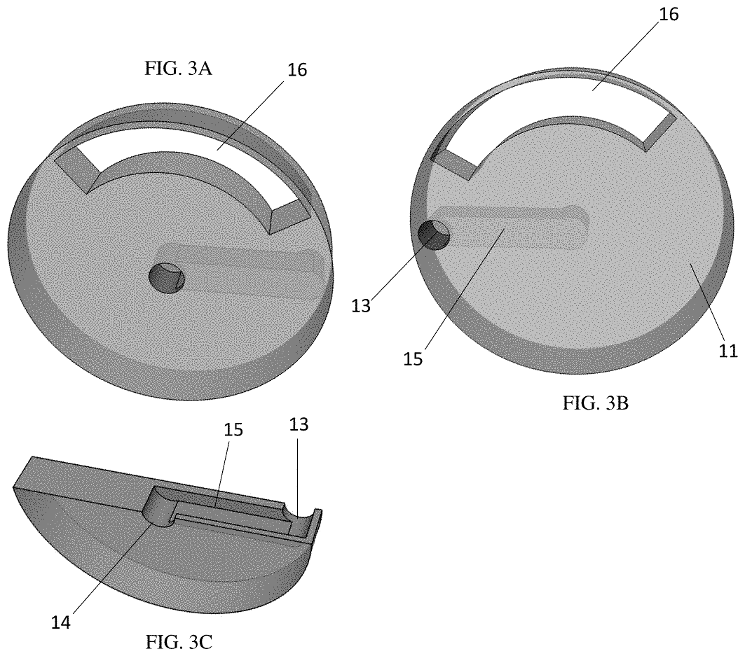

The disks are held tightly together so that the air does not escape through the gap between the rings. The diameter of the LD is the same or larger than the diameter of the UD. The UD has a Feeding Hole (FH) (13) near its circumference which is open on the bottom edge but not all the way to the top edge. Air from an air pump is supplied to the UD via a tube (17) that is connected to the center of the UD. A channel (15) on the bottom side of the UD guides the air to the FH (13). The UD has a deflation channel (16) that is cut-out all the way through from the top surface to the bottom surface. The deflation channel (16) may take the shape of a semicircle as shown in FIG. 3A-B. The deflation channel is located in the front (ahead) of the FH (13) (i.e. in the direction of rotation of the UD), and is located at the same distance from the center as the FH (13). The width of the channel is the diameter of the FH (13). The UD rotates clockwise, while the LD (12) is stationary with respect to the UD (11).

The LD (12) has several holes in its circumference (18) that are the same size as the FH (13) in the UD (11) and are at the same distance from the center as the FH (13) in the UD (11). Therefore, as the UD (11) rotates, the FH (13) in the UD (11) will be exactly aligned with one of the holes (18) in the lower disk (12). So the air being pumped into the FH (13) feeds into one hole (18) in the bottom disk thus feeding air to one of the rings (10) around the patient's arm or leg whereby the nozzles (20) in the ring (10) will spray a jet of air onto the patient's arm or leg while simultaneously inflating the ring (10) thus applying pressure to that part of the arm or leg as well. Each group of nozzles (20) from one ring (10) surrounding the arm or leg are fed by one tube (19) that is attached to one of the holes (18) on the LD. As the UD (11) rotates, its FH (13) will be aligned to the next hole (18) in the LD (12) thus repeating the same scenario (spraying a jet of air onto the patient's arm or leg and simultaneously inflating the ring thus applying pressure to that part of the arm or leg). This cycle is repeated as long as the UD is rotating. Thus, one ring (10) after another is energized from bottom to top, and the rings remain inflated. Thus, the pressure around the arm or leg is applied from bottom to top, which helps move accumulated fluid back into the lymphatic vessels. Thus, the air pressure hitting the arm or leg from the nozzles is like an air pressure “wave” moving from bottom to top similar to a hand-applied lymphatic drainage massage, which helps in the circulating of the lymphatic fluids and scavenging them back into the lymphatic vessels.

The deflation channel (16) is several holes behind the FH (13). Thus, as the rings (10) are energized and apply pressure to the arm or leg in an upward motion, the holes (18) connected to rings (10) several stages down will be aligned with the deflation channel (16). Thus, the air will escape out of the rings (they are deflated) and the rings are ready for a new cycle. In use, the device has several consecutive rings being inflated upwards while several rings further down are being deflated. At any one time, at least two adjacent rings are inflated at a time to ensure that the fluid is not released back down the arm or leg.

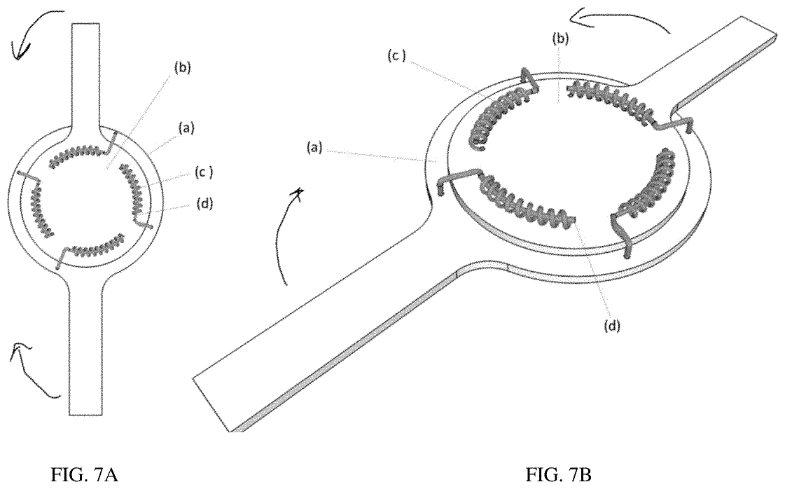

In some embodiments, the device comprises a motor operably coupled to the air control unit. The pump and the motor rotating the UD may be powered from a battery that is charged from a regular wall outlet and/or from energy harvested from the movement of the knee or elbow of the patient. The harvested energy may be used to charge the battery. The energy from the movement of the patient wearing the device is harvested using the induction law investigated by Faraday. With reference to FIG. 7, at the knee or elbow, there are two overlapped circular disks. The outer disk (a) of the securing garment is connected to the thigh or upper arm while the inner disk (b) is fixed to the lower leg or arm. A set of magnetic bars (d) is attached to the outer disk (a) with a set of coils (c) attached to the inner disk (b). As many pairs of coils (c) and magnets (d) may be placed as possible in the space given to maximize the energy generation. When the knee or elbow moves inward or outward, the magnets (d) move in and out of the coils (c) to generate electricity. The electricity generated is alternating current and can be converted into DC using rectifiers. The coils (c) and the magnets (d) may be arranged in a circular shape to allow the magnet to move freely in the coils to generate more power. As shown in FIG. 7, the coils and magnet may be arranged on in the inside of the knee while the outside of the knee is utilized for the air pump.

In some embodiments, an indicator is placed in a visible location where the patient can see it which displays the amount of energy that has been harvested from the movement of the knee or elbow. The indicator may act as a psychological incentive for the patient to move their leg or arm, which in-of-itself (the movement of the limb) will stimulate the smooth muscles thus activating the lymphatic vessels and encouraging the natural drainage action of the lymphatic vessels. Thus, the patient will be motivated to move their limb to achieve higher scores or to maintain their level of accomplishment. This will help to positively change the patient's behavior and encourage them to move their limbs thus making it a habit that will help in a faster recovery for the patient.

In some embodiments, the device provides a pressure up to 140 mmHg when applied to a leg or up to 30 mmHg when applied to an arm. Each compression and decompression phase can last from 1-100 seconds or more, e.g. for 15-90 seconds. In some embodiments, the device may be configured to provide pressure in a peristaltic manner, such as several impulses per minute (e.g. 2-5) with a delay (e.g. 1-15 seconds) between each impulse. The user may adjust the setting of the device using a timing control knob of a microcontroller board which controls all of the device functions.

Embodiments of the disclosure provide a method for preventing or reducing edema or swelling in a subject in need thereof, comprising attaching a device as described herein to an arm or leg of the subject. In some embodiments, the rings are an unbroken and thus must be slid onto the arm or the leg, starting with the ring closest to the knee or elbow. In other embodiments, the rings have an opening that enables the ring to be wrapped around the limb and secured, e.g. via a hook and loop fastener.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A device for applying air pressure to a portion of a body of a person, comprising a garment configured to be arranged distally of a joint of the body of the person, wherein the garment comprises:
a plurality of hollow rings configured for arrangement along a length of the garment, each of the plurality of hollow rings having a skin contacting surface including a series of holes for supplying air directly to skin of the portion of the body of the person, wherein the skin contacting surface is formed substantially from an airtight material, wherein each of the holes define an opening only in the skin contacting surface, and wherein each of the holes are in fluid communication with an interior of the hollow ring on which the hole is located.

2. The device of claim 1, further comprising an air control unit, wherein the air control unit comprises
an air inlet rotatably-coupled to a surface of a first component of the air control unit and fluidly coupled to an air outlet on an opposing surface of the first component, and
a plurality of air outlets disposed through a thickness of a second component of the air control unit, each of the plurality of air outlets being fluidly connected to a corresponding one of the plurality of hollow rings.

3. The device of claim 2, wherein the first component and the second component are rotatably-coupled about a central axis of the air control unit.

4. The device of claim 2, wherein the air inlet is arranged at the central axis of the air control unit.

5. The device of claim 2, further comprising an air channel disposed through the thickness of the first component of the air control unit, wherein the air channel is fluidly-coupled with at least one of the plurality of air outlets disposed through the thickness of the second component of the air control unit based on a rotation of the first component and the second component about the central axis of the air control unit.

6. The device of claim 2, further comprising a motor operably coupled to the air control unit.

7. The device of claim 6, further comprising a pump fluidly-coupled to the air inlet of the first component of the air control unit.

8. The device of claim 7, further comprising processing circuitry configured to supply, via the pump, air to the air inlet of the first component of the air control unit, and rotate, via the motor and about the central axis of the air control unit, the first component of the air control unit relative to the second component of the air control unit.

9. The device of claim 1, further comprising a magnetic inner disk and a magnetic outer disk configured to be arranged at the joint of the body of the person, wherein the inner and outer disks are rotatably coupled, relative rotation therebetween generating storable energy.

10. The device of claim 1, wherein each of the plurality of hollow rings is separately attachable to the body.

11. A method for reducing edema in a subject in need thereof, comprising attaching a device of claim 1 to an arm or leg of the subject.
